(19) United States
(12) Patent Application Publication
(10) Pub. No.: US 2005/0168775 A1
(43) Pub. Date: Aug. 4, 2005

(54) Method and computer program product for in-house digital photo/card processing and printing/cutting production

(76) Inventor: K. Clive Liu, Los Altos Hills, CA (US)

Correspondence Address: K. Clive Liu, 25426 Adobe Lane, Los Altos Hills, CA, 94022, US

(21) Appl. No.: 11/044,280

(22) Filed: Jan. 26, 2005

Related U.S. Application Data
(60) Provisional application No. 60/539,433, filed on Jan. 26, 2004.

(51) Int. Cl. G06F 15/00

(52) U.S. Cl. 358/1.15

(57) ABSTRACT

The invention provides a method, apparatus, a computer-implemented process, systems and program products for in-house digital photo printing and digital color reproduction. The present invention allows a user to print digital photos, business cards, name cards, ID cards, post cards etc. in-house by using standard page-size or custom-size sheets of paper, in sheets or rolls, with software program product, computer, printer, and cutter. Users prepare the digital photos or a card design. Depending on the size of the photo or card required, the program product automatically generate page-size or custom-size sheet layout so that each photo sheet printed with multiple photos or multiple impressions of the card design, will minimize the paper waist and when individual photos or cards are cut from the photo sheet, they will end up a full-bleed and 100% clean edge photos or cards. A fully integrated system that is small and flexible to be used anywhere, can be implemented that use this invention to integrate the printer and cutter in one machine with a micro processor to run the software program.

This application claims priority under 35 USC 119(e) of co-pending provisional application No. 60/539,433 filed Jan. 26, 2004 entitled Method and Computer Program Product for In-House Digital Photo Printing & Card Reproduction, hereby incorporated by reference in its entirety.

### BACKGROUND OF THE INVENTION

1. Field of the Invention

This invention relates to the in-house digital image processing, photo/card processing and printing, and digital color reproduction. This invention also relates to a computer program product and the in-house digital photo/card finishing system for photos, business/ID cards and post cards printing.

2. Background

With the popularity of digital cameras and improved digital printing technology, business users are starting to process their digital photos in-house. Companies are starting to produce various business and ID cards in-house. Consumers are also printing their digital photos with their personal computer and inkjet printer at home.

Small businesses and medium/large size companies regularly purchase color reproductions and professional color printing services from offset printing press or on-demand color printers. All companies produce name cards for individuals who work for the company. Name cards are usually exchanged during introductions and provide important information-name, affiliation, title, street/email addresses, phone/fax numbers and often including the company logo. Due to the need of doing business with different ethnic groups, name cards are often printed on both sides with more than one language. Name cards must be provided in color with superior quality for salespeople working for any size of a company. For companies offering services, the trend of name cards are often including the individual's photo, so it is friendly and distinguishable for customers who receive the card. For security purposes, larger corporations often produce identification (ID) cards for employees to access the building or work area.

The prior art of digital photo processing is that consumers upload their digital photo to a processing center or visit a service store and get their photos processed and printed. Recent inkjet printers can print stunning photos that can last for many years, similar to the traditional color photographs. Business users and consumers started to process their digital photos using imaging software running on the personal computer and print photos with the inkjet printer. By doing the photo processing in-house or at home, it saves effort from uploading photos for processing by a remote service center and waiting for the photos to be mailed back; or dropping off the digital media such as SmartMedia, Flash Memory and others for processing/printing digital photos at a local photo store. However, doing the photo processing in-house requires a skillful computer user to learn photo-editing software such as Adobe® Photoshop in order to combine photos then printing onto a single letter or A4 size paper. If each photo remained on the letter-size or A4 paper, it incurred a lot of paper waist when each photo needs to be all placed in portrait or landscape orientation for easy viewing. If each photo is cut from the standard page-size paper, the process then involved in cutting by hand using a tedious and often dangerous cutter. Most recent personal lab inkjet printers by HP, Lexmark, Epson and Canon, allows printing each 4×6 photo on the 4×6 photo-size sheet or roll paper without using the computer. However, it takes a lot of time to process and print each digital photo one by one. The cost of paper plus ink normally ends up no saving compared to the processing the photos at a photo lab using silver-halide photo paper.

Another problem is that of processing the photos in-house or at home using photo processing software such as Adobe® Photoshop Album, Microsoft® Picture It or Microsoft® Office Picture Manager. This type of software is easy enough so users don't require much learning effort. The software provides photo layout functions, so users can easily choose a layout with a number of photos and print them on the page-size photo paper. The methods developed by the software are useful for combining a few photos into a single page and allowing an efficient usage of the standard-size paper. However, the methods do not produce the photos printed on a letter or A4 size paper centrally to both X and Y axies. In addition, each photo is printed to the exact size without the over-print consideration, so each finished photo could be easily 1 mini-meter smaller, or leaving un-wanted 1 mini-meter white edge, after users further divide each photo page into the individual photos through cutting by hand or machines.

The prior art of business card printing mainly used the printing process known as Offset Press and recent On-Demand Printing. One major problem of the commercial printing process is that, for any job, it takes days or weeks to prepare all the necessary steps before putting the job on the press. Color inkjet and laser printers have been used in-house for color reproduction in the past few years. Many business applications were developed for in-house color printing. For example, business users started to business card print production using Avery® software solutions with several types of paper supplies that are ready to feed to the inkjet printer, produce the print, fold the paper along the cut line, then “snap” each card apart from the sheet. By doing the color reproduction in-house, it saves tremendous time to wait for the job turn-around from the press. However, each card snapped from the printed sheet could not be produced with 100% clean edges as they would from the cutters.

Another problem is that of doing business/name cards, ID cards, post cards reproduction in-house using creative software such as QuarkXpress, Adobe Illustrator, PageMaker, PhotoShop, CorelDraw etc. This method requires a skillful computer user to use the functions provided in the software to produce the multiple copies of the photos and cards on the same page for print. Not only it requires steep learning, it also takes much longer time to design the page and process the page for printing.

Other software such as Adobe® Photoshop Album or Microsoft® Picture It could be used to replicate the copies of the image of the card for print. This type of software is easy enough so users don't require much learning effort. The methods developed by the software are useful for easy replication of an image of a card deign, produced by the above creative software, into multiple copies on a single page. However, the methods do not produce the cards printed on a letter or A4 size paper centrally to both X and Y axies. In addition, each card is printed to the exact size without the over-print consideration, so each finished card could be easily 1 mini-meter smaller, or leaving un-wanted 1 mini-meter white edge, after users further divide each photo page into the individual cards through cutting by hand or machines.

It would be advantageous to provide a computer program product that takes standard or custom-size paper for printing on the desktop printers to reproduce the photos and cards on the standard-size or custom-size sheet paper. Coupling the computer program and cutting device, the system can be operated by a personal computer with a separated color printer and cutter, or an integrated printer and cutting device. The system is small enough to put on your desktop in an office environment for in-house color reproductions. The computer program product is easy to operate that any photo/image enhanced by the photo editing software, or card/design made by creative software can be easily and quickly combined or replicated into multiple images on the same page, according to the layout to maximizing the usage of the paper. Multiple prints on the standard or custom-size paper are centrally to both X and Y axies. In addition, each photo/card is printed to the exact size with the over-print consideration, thereore, they can be further divided into each individual print by a cutter or a cutting device integrated in the printer to produce 100% clean-edge photos or cards in the exact standard size, and the image is covered to the edge of each photo/card. The computer program product and the cutting device offers the fast turn-around for the color reproduction of photos, photo cards, business cards, name cards, ID cards, post cards etc. that are completely done in-house.

### SUMMARY OF THE INVENTION

The invention provides a method, apparatus, a computer-implemented process and a program product for in-house digital image processing, photo/card processing, printing, and digital color reproduction. The prior art of digital photo processing/printing at a photo lab or a service center has been that each photo is imaged individually on one or more roll-feed paper that each roll is used for the photo prints with the specified width. The lab system then cut each individual photo to its required length to finish the photo processing. At office or home, users print their digital photos on the page-size paper (US Letter or A4) sold as sheets, or on photo-size paper (3.5×5, 4×6, 5×7 etc.) sold as sheets or rolls. Users also use some program products such as Adobe® Photoshop Album, Microsoft® Picture It or Microsoft® Office Picture Manager to combine a few photos for printing on the standard size paper. The methods used to combine photos in these programs do not produce the photos printed on a letter or A4 size paper in the abusolutely center position for both X and Y axies. In addition, each photo is printed to the exact size such as 3×5, 4×6 etc. without the over-print, so each finished photo could be easily 1 mini-meter smaller, or leaving un-wanted 1 mini-meter white edge, after users further divide each photo page into the individual photos through cutting by hand or automatic machines. Therefore, photos printed on the page are often kept on the same page for viewing, without further steps to divide the page into individual photo with the exact size and 100% clean edge. The present invention allows digital photos to be composed as one or more photo pages, and imaged each photo page onto a pre-cut, page-size or custom-size sheet of paper to maximize the usage of the paper based on the photo size required. Each photo is imaged, line-by-line, with 1 mini-meter over-printing on each side of the photo processed; resulting a minimum gap of 1 mini-meter between adjacent photos on both X & Y directions; all photos are properly imaged on the sheet with equal width of white spaces to the edge of the sheet on both X & Y directions. On all photo sheets printed, which each sheet contains one or more photos, is then cut down to final individual photos along both X & Y directions with 1 mini-meter bleed by a separate cutting steps or machines.

The prior art of in-house business card reproduction has been that each card is designed by office or creative software, and then each card is duplicated into several copies to fit in one page. Avery® provides several types of paper supplies that are ready to feed to the printers and produce the prints, fold the paper along the cut line, then “snap” each card apart from the sheet. The methods used to allow the duplications of each card to fit the cut lines on a letter or A4 size paper that the cards on the same sheet are not in the abusolutely center position for both X and Y axies. In addition, each card is printed to its exact size without the over-print capability, so each finished card could be easily 1 mini-meter smaller, or leaving un-wanted 1 mini-meter white edge, after users further divide each card page into the individual cards through cutting by hand or automatic machines. The methods produce business cards that are “snapped” from the Avery® paper supplies resulted in cards are not always produced with 100% clean edge, and can be on single-side only. The present invention allows the business card to be replicated as multiple copies as one photo page, and each photo page is printed onto a pre-cut, page-size or custom-size sheet of paper to maximize the usage of the paper based on the photo size required. Each card is imaged, line-by-line, with 1 mini-meter over-printing on each side of the photo processed; resulting a minimum gap of 1 mini-meter between adjacent cards on both X & Y directions; all cards are properly imaged on the sheet with equal width of white spaces to the edge of the sheet on both X & Y directions. On all photo sheets printed, which each sheet contains one or more cards, is then cut down to final individual card along both X & Y directions with 1 mini-meter bleed by a separate cutting steps or machines.

Another aspect of the invention integrates the process of producing the custom-size paper; designing the optimized page layout for each size of the image printing; previewing the photo page(s) such that each photo page contains one or more photos (images), or multiple prints (images) of the card; printing each photo page in such way that each image is printed, line-by-line, with 1 mini-meter over-printing on each side of the image processed; resulting a minimum gap of 1 mini-meter between adjacent images on both X & Y directions; all images are properly printed on the sheet with equal width of white spaces to the edge of the sheet on both X & Y directions, to produce one or more photo sheets; cutting each photo sheet into individual print by a separate cutting steps or machines.

The invention changes how the digital photos, photo cards, business cards and other prints are made in-house. The prior art of in-house digital photo printing and digital color reproduction required the use of standard page-size paper or paper with the final finished size. Hence, it either involves more paper waist, or each print produced takes more time or cost more. The final prints are not always produced with 100% clean edge, using the program product with no over-print consideration and bleeding cutline manually or by machines. All images are not symmetrically laid down on the sheet that caused errors when feeding the sheet into the cutting machine. The invention integrates the process from using a custom paper size or standard page size with a program product to produce the photo pages for preview; print each photo sheet, line-by-line, with 1 mini-meter over-printing on each side of the image processed, resulting a minimum gap of 1 mini-meter between adjacent images on both X & Y directions from the desktop inkjet/laser printer; and cutting along both X & Y directions with 1 mini-meter bleed by a separate cutting steps or machines. The result is a low-cost, easy, safe, error-free and an efficient system for in-house digital photo printing and digital color reproduction.

The foregoing and many other aspects of the present invention will no doubt become obvious to those of ordinary skill in the art after read the following detailed description of the preferred embodiments that are illustrated in the various drawing figures.

### DESCRIPTION OF THE DRAWINGS

FIG. 1 illustrates a conceptual overview of a preferred embodiment the invention;

FIG. 2 illustrates a structure overview and a computer system, program product, printer and cutter capable of using the invention in accordance with a preferred embodiment;

FIG. 3 illustrates a high level schematic showing the in-house digital photo printing pursuant to the method of the present invention;

FIG. 4 illustrates a high level schematic showing the in-house business card printing pursuant to the method of the present invention;

FIG. 5 illustrates a high level schematic showing the designing and operating a photo, business/post card printing system using Letter/A4 size printers pursuant to the method of the present invention;

### DESCRIPTION OF THE PREFERRED EMBODIMENTS

### Detailed Description

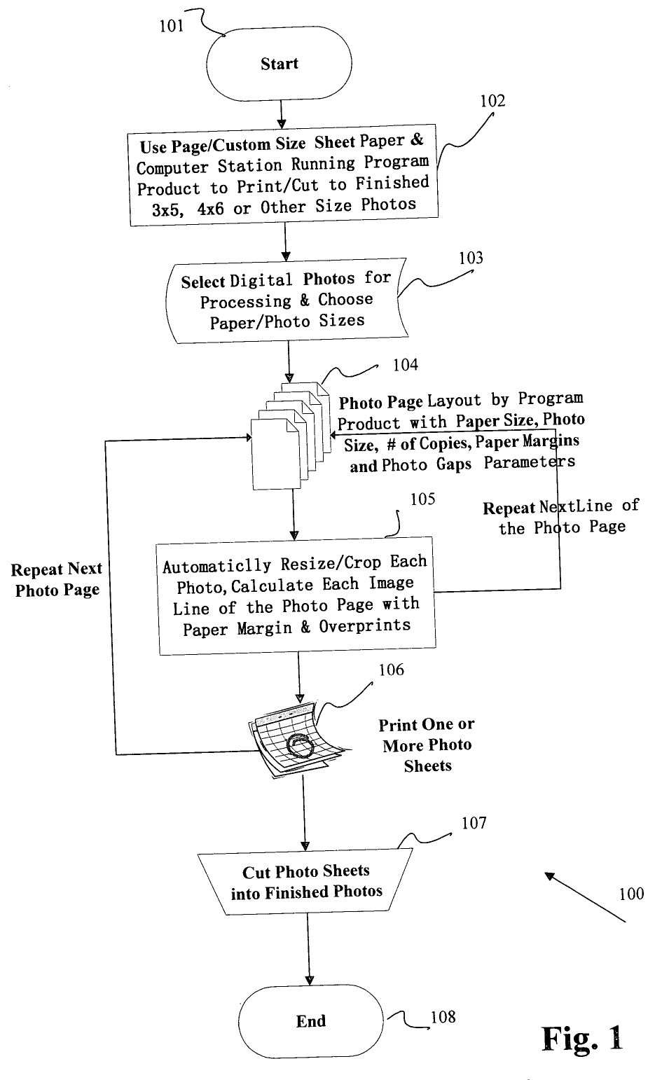

FIG. 1 illustrates a conceptual overview of a preferred embodiment of the invention, indicated by general reference character 100, for in-house digital photo processing and printing production. The process 100 initiates at a “start” terminal 101 after users have prepared digital photos for printing production. At the step 102, users use standard page-size (US Letter or A4) or custom-size sheet paper, computer station running the program product to print and cut the page-size or custom-size sheet into finished 3×5, 4×6 or other size photos, using the layout generated by the program product. At the step 103, users select the digital photos for processing and choose the paper size and photo size as one job. The program product then automatically generates one or more photo pages 104, with input parameters such as paper-size, photo-size, number of copies, paper margins and photo overprints and gaps. At the step 105, the program product automatically resize and crop each photo, and calculate each image line of the first photo page such that keeping the left margin equals to the right margin, and the top margin equals to the bottom margin, and extending four edges of each photo to include over-prints. The step repeats at the steps 104 and 105 to generate the next image line until the last image line of the first photo page. The program product then prints the photo page to produce page-size or custom-size photo sheet 106, then repeat at the steps 104 and 105 to generate image lines for the next photo page and produce one or more photo sheets 106. At the step 107, users cut these photo sheets into individual photo in final finished size. The process 100 completes through an “end” terminal 108.

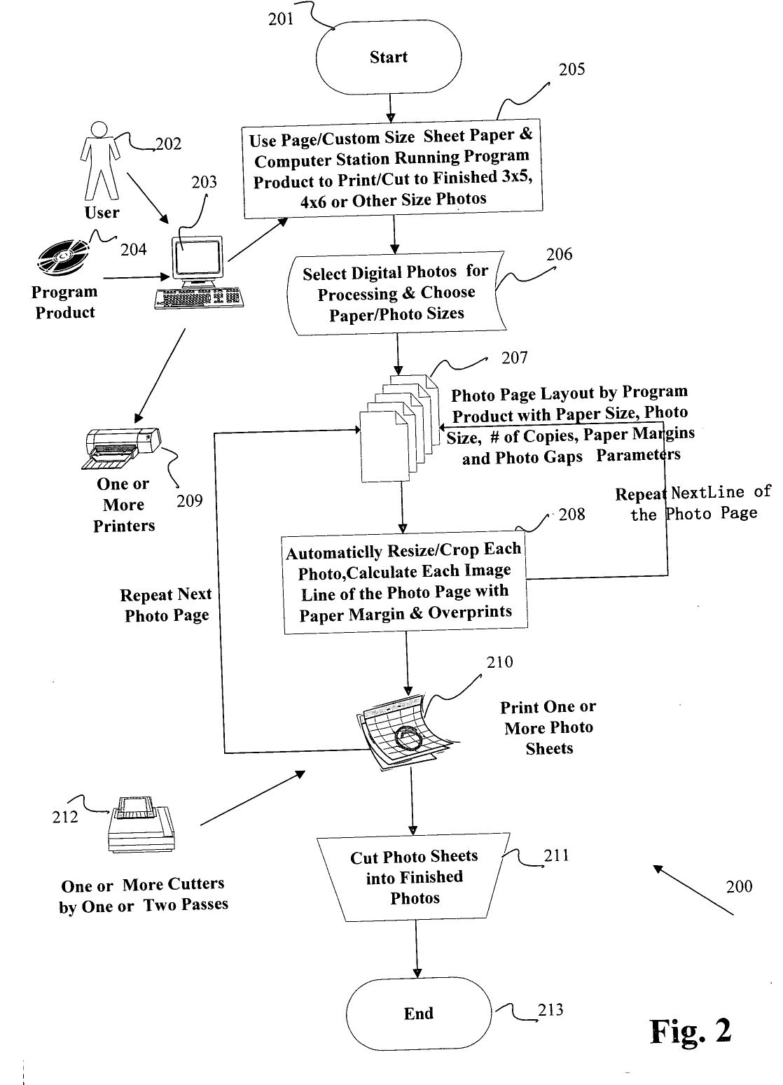

FIG. 2 illustrates a structure overview and a computer system, program product, printer and cutter capable of using the invention in accordance with a preferred embodiment for in-house digital photo processing and printing production, indicated by general reference character 200. The process 200 initiates at a “start” terminal 201 after a user 202 has prepared digital photos for printing production at computer station 203. The computer station runs a program product 204 that automatically generates one or more photo pages, with input parameters such as paper-size, photo-size, number of copies, paper margins and photo overprints and gaps. At the step 205, user 202 chooses standard page-size (US Letter or A4) or custom-size sheet paper and operates the computer station 203 that runs the program product 204. At the step 206, users select the digital photos for processing and choose the paper size and photo size as one job. The program product 204 then automatically generates one or more photo pages 207, with input parameters such as paper-size, photo-size, number of copies, paper margins and photo overprints and gaps. At the step 208, the program product 204 automatically resize and crop each photo, and calculate each image line of the first photo page such that keeping the left margin equals to the right margin, and the top margin equals to the bottom margin, and extending four edges of each photo to include over-prints. The step repeats at the steps 207 and 208 to generate the next image line until the last image line of the first photo page. The program product 204 then prints the photo page to produce page-size or custom-size photo sheet 210, then repeat at the steps 207 and 208 to generate image lines for the next photo page and produce one or more photo sheets 210. At the step 211, users cut these photo sheets into individual photo in final finished size by one or more cutters 212 in one or two passes. The process 200 completes through an “end” terminal 213

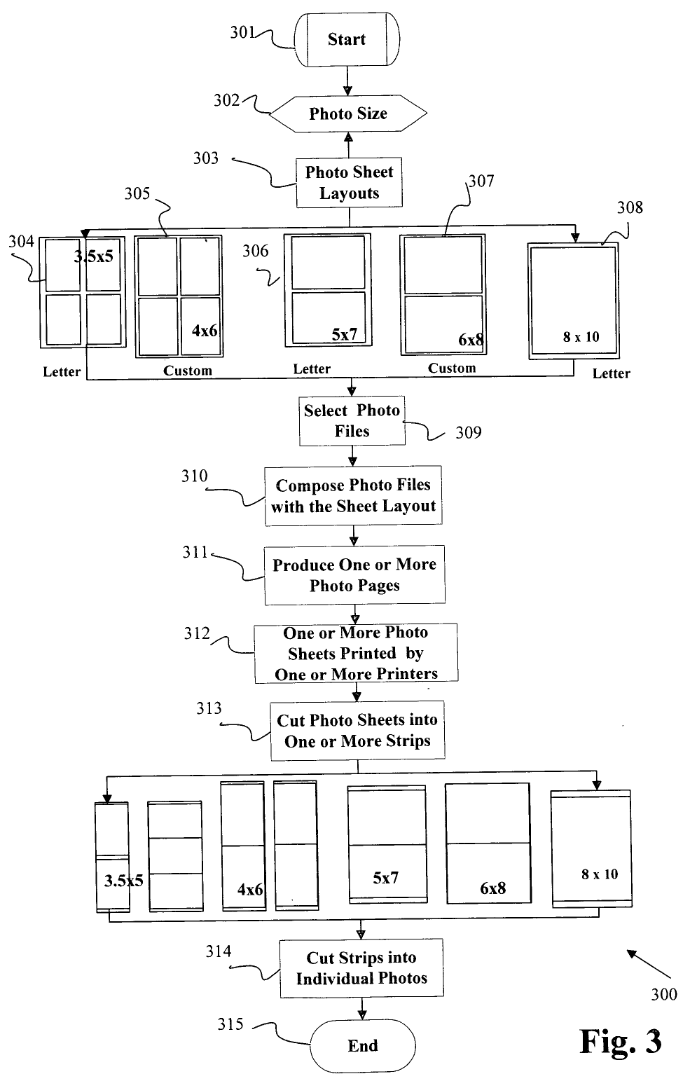

FIG. 3 illustrates a high level schematic showing the in-house digital photo printing pursuant to the method of the present invention, indicated by general reference character 300. The process 300 initiates at a “start” terminal 301 after the user has prepared digital photos ready for printing. A “Photo Size” decision step 302 enables the program product to generate layouts for the photo size at step 303, with other parameters such as paper-size, paper margins and photo overprints and gaps such that the layout is optimized for the photo size required, with minimum paper waist and easy to operate and cut. The program product generates the layout sheet 304 for 3.5×5 photos, the layout sheet 305 for 4×6 photos, the layout sheet 306 for 5×7 photos, the layout sheet 307 for 6×8 photos and the layout sheet 308 for 8×10 photos. At the step 309, the user selects digital photos in JPEG or other formats for printing. At the step 310, digital photos selected are composed in sequence using the layout sheet that is optimized for the photo size required. At the step 311, one or more photo pages using the sheet layout chosen at the “Photo Size” decision step 302 are generated. At the step 312, the user prints these photo pages by one or more printers using pre-cut page-size or custom-size photo paper for the layout sheet 304, 305, 306, 307 and 308 and produces one or more photo sheets. At the step 313, the user cuts these photo sheets into one or more strips. At the step 314, the user cuts these photo strips into individual photos. The process 300 completes through an “end” terminal 315

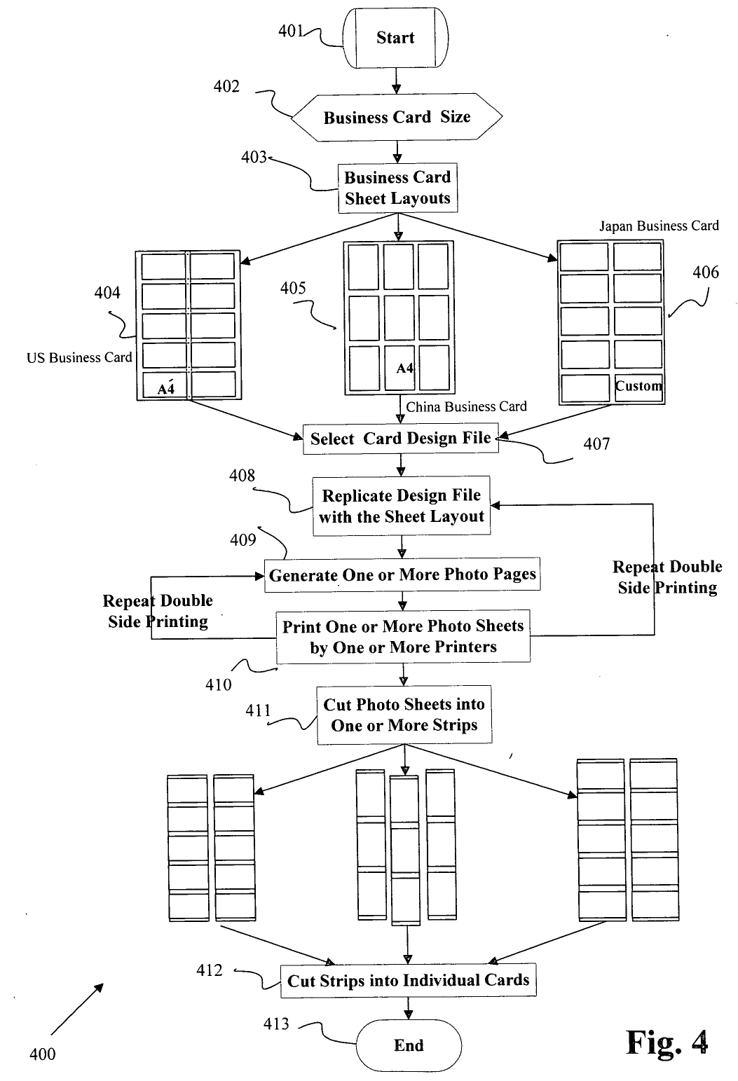

FIG. 4 illustrates a high level schematic showing the in-house business card printing pursuant to the method of the present invention indicated by general reference character 400.

The process 400 initiates at a “start” terminal 401 after the user has prepared a business card design in electronic format and is ready for printing production. A “Business Card Size” decision step 402 enables the program product to generate layouts for the business card size at step 403, with other parameters such as paper-size, paper margins and business card overprints and gaps such that the layout is optimized for the business card size required, with minimum paper waist and easy to operate and cut. The program product generates the layout sheet 404 for US business card, the layout sheet 405 for China business card and the layout sheet 406 for Japan business card. At the step 407, the user selects the business card design file for printing production. At the step 408, the business card design file selected is replicated into multiple impressions using the sheet layout that is optimized for the business card size, bleeding and paper margin required. At the step 409, one or more photo pages using the sheet layout chosen at the “Business Card Size” decision step 402 are generated. At the step 410, user prints these photo pages to produce one or more page-size or custom-size photo sheets, by one or more printers for the layouts 404, 405, 406, then repeat at the steps 408 and 409 to produce one or more page-size or custom-size back-side photo sheets 410. At the step 411, the user cuts these photo sheets into one or more photo strips. At the step 412, the user cuts these photo strips into individual cards. The process 400 completes through an “end” terminal 413

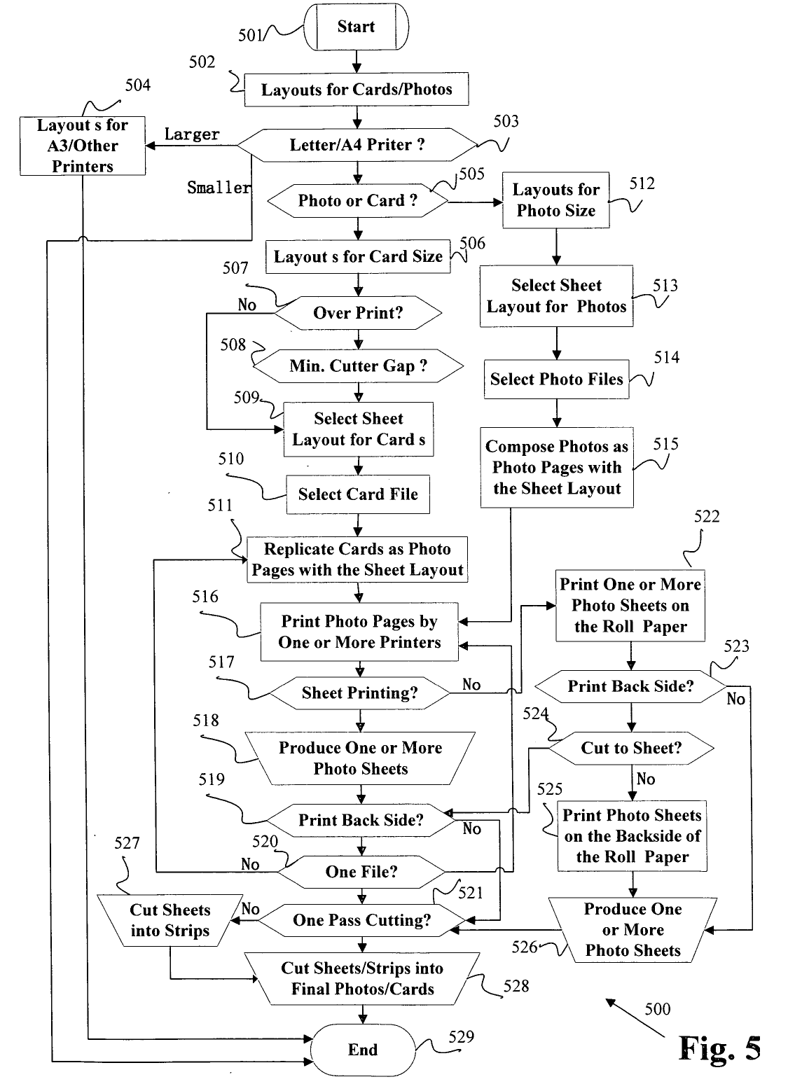

FIG. 5 illustrates a high level schematic showing the designing and operating a photo, business card, post card printing system using Letter/A4 size printers pursuant to the method of the present invention indicated by general reference character 500.

The process 500 initiates at a “start” terminal 501 after the user has prepared photos or business card, post card design in electronic format and is ready for printing reproduction. Step 502 provides layouts for cards and photos of different sizes for a standard Letter/A4 size printer to produce photo sheets that have minimum or no paper waist to include multiple impressions of the card, or the group of photos selected. A “Letter/A4 Printer Size” decision step 503 selects the next step 504 “Layouts for A3/Other Printers” to provide layouts for cards and photos of different sizes to fit in a larger sheet, if a larger size printer is used for printing reproduction. The step 504 continues at an “end” terminal 529 and completes the process 500. If a smaller size printer is used, process 500 completes through an “end” terminal 529.

For Letter/A4 size printers, a “Photo or Card Printing” decision step 505 selects business/post card layouts at step 506 “Layouts for Card Size” for producing cards with required size. The “Over Print” decision step 507 checks the next decision step “Minimum Cutter Gap” 508 for the gap between blades of the cutters used, then at the step “Select Sheet Layout for Cards” 509, chooses the sheet layout for the card size and the correct cutter in production. The “Over Print” decision step 507 goes to step 509 directly if the card design does not require inks printed to the edge of the card. The step 510 selects the card design file and replicates the card design into the multiple impressions of the card to fit the sheet layout chosen and produce one or more photo pages at the step 511 “Replicate Cards as Photo Pages with the Sheet Layout”, depending on the quantity of the cards required. The process continues at the step 516.

The “Photo or Card Printing” decision step 505 selects photo layouts at step 512 “Layouts for Photo Size” for producing photos with required size. The step 513 selects the sheet layout for the photo size required. The step 514 selects photo files and composes the photo to produce one or more photo pages at the step 515 “Compose Photos as Photo Pages with the Sheet Layout”, depending on the quantity of the photos required. The process continues at the step 516.

The step 516 prepares photo pages generated for printing on one or more printers. A decision step 517 checks whether to feed the printer by a pre-cut sheet paper or a roll of paper. If pre-cut sheets are used, one or more photo sheets are produced at the step 518. A decision step 519 checks whether double-side printing is necessary. If the job requires double-side printing, a decision step 520 checks whether the front and backsides of the card design are included in a single electronic file. If one file is used, the process continues at the step 516 and feed the backside of the sheet for printing the backside of the photo pages produced by the card design at the step 518. Then, the process continues at the decision step 521. If the job requires only single-side printing, the process goes from the step 519 to the decision step 521.

At the decision step 517, if printers take only roll paper, the process continues at the step 522 that one or more photo sheets are printed on the roll paper. A decision step 523 checks whether double-side printing is necessary. If the job requires double-side printing, the decision step 524 checks if the printer needs to cut the paper from roll paper to a sheet paper. If cutting to sheet is required, the process continues at the decision step 520. If the printer allows backside printing on the roll paper, the process continues to print one or more photo sheets on the backside of the roll paper at the step 525. At the step 526, each photo sheet is cut from the roll paper to produce one or more photo sheets with double-side printing. At the decision step 523, if the job requires single-side printing, the process continues at step 526 that each photo sheet is cut from the roll paper to produce one or more photo sheets with single-side printing. Step 526 continues at the decision step 521.

At the decision step 521, sheets are cut into the final sizes of cards and photos at the step 528, if “One Pass Cutting” is used. Otherwise, sheets are cut into strips at step 527, and then continued at step 528 to produce the final sizes of cards and photos. The process 500 completes through an “end” terminal 529.

One skilled in the art will understand that the invention provides a flexible and efficient method and apparatus for the in-house digital photo printing and digital color reproduction.

From the foregoing, it will be appreciated that the invention has (without limitation) the following advantages:
1) For in-house digital photo printing, the invention provides an easy and efficient software solution by using the computer program product with a PC, printer and automatic cutter to produce one or more photos from a standard page-size (Letter/A4) or a custom-size photo paper;
2) For in-house digital color reproduction, the invention provides an efficient, low-cost, chemical-free system for photo cards, business cards, name cards, ID cards and post cards printing production. Retail businesses and small/medium size companies can produce these cards within the same day compared to many days or weeks turn-around time if printed by an offset printing press or a commercial printer;
3) Home and business users can use standard page-size or custom-size paper for the printing to save the print cost and minimize the paper waist. Instead to “snap” each card apart from the sheet, users can use the automatic cutter to divide individual print apart from the sheet to produce each photo or card with all the image printed to the edge and 100% clean edges after cut;
4) A system that is small and flexible to be used anywhere. The invention provides a desktop-size system that requires no special setup to operate a digital photo lab or a quick printing press. The invention offers an easy-to-use software that requires no special training to process digital photos and color card printing productions;
5) A fully integrated system can be further designed that use this invention to integrate the printer and cutter in one machine with a micro processor to run the software program. The integrated machine running the software program, receiving images and parameters from user through the LCD display, processing the selected image(s), printing the photo pages, and producing the finished size of photos, photo cards, business/name cards and post cards.

While the invention has been herein shown and described in what is presently conceived to be the most practical and preferred embodiment thereof, it will be apparent to those of ordinary skill in the art that many modifications may be made thereof which scope is to be accorded the broadest interpretation of the appended claims so as to encompass all equivalent methods and processes.

Although the present invention has been described in terms of the presently preferred embodiments, various modifications and alterations can be made without departing from the scope of the invention. Accordingly, the scope of the invention is not to be limited to the particular invention embodiments discussed herein, but should be defined only by the appended claims and their equivalents.

1. A method and computer program product for in-house digital photo processing and printing using standard page-size sheet/roll paper, software program, computer, printer and cutter; comprising the steps of:
(a) The software program composes the selected digital photos for printing by placing each photo on the photo page according to the paper size, photo size, number of copies, paper margins and gaps between adjacent photos, and produces one or more photo pages for preview;
(b) For each photo page, each photo is processed automatically by resize, crop image processing functions;
(c) Printing each photo page by keeping the left margin equals to the right margin, and the top margin equals to the bottom margin;
(d) Printing each photo by extending four edges of the photo to include over-print.

2. The software program of claim 1, further including to compose the selected photos for printing using custom-size sheet/roll paper by placing each photo to be printed in one size among 3×5, 4×6, 5×7, 8×10 etc., to produce one or more photo pages according to the paper size, photo size, number of copies, paper margins and gaps between adjacent photos; such that the placement minimizes the over-print/gap size between adjacent photos and minimizes the waist of the paper for the left/right and top/bottom margins.

3. The software program of claim 1, further including previewing each photo of one or more photo pages, and processing each photo with brightness, contrast, saturation, sharpness image processing functions, and then printing each photo according to the parameters of the image adjustment saved for the photo.

4. The software program of claim 1, further including producing one or more photo pages of the selected photos, and leaving minimum two mini-meters of paper margins, and minimum three-mini meters of over-print and gap between adjacent photos.

5. The software program of claim 1, further including printing each photo by calculating the 1^{st} line of the 1^{st} photo, extending the line of the photo by an amount for the over-print in both directions, adding the gap between the over-print of two adjacent photos, then calculating the 1^{st} line of the 2^{nd} photo, combining the extended 1^{st} lines of the 1^{st} and 2^{nd} adjacent photos, then calculating the 1^{st} line of the 3^{rd} photo of the same Y coordinate, and finally, sending the complete line of the same Y coordinate to the printer; then repeat the same steps by sending the 2^{nd}, 3^{rd} line and so on to complete the printing.

6. A method and computer program product for in-house photo card, business card processing and printing using standard page-size sheet/roll paper, software program, computer, printer and cutter; comprising the steps of:
(a) The software program replicates the card as multiple instances of one image and places all the instances on one photo page for preview, according to the paper size and business/photo card size;
(b) The business/photo card is processed automatically by resize, crop image processing functions, then producing instances of the business/photo card according to the number of cards needed;
(c) Printing each photo page by keeping the left margin equals to the right margin, and the top margin equals to the bottom margin;
(d) Printing each business/photo card by extendng four edges of the card to include over-print;
(e) Repeat step (a) for the back side processing and printing.

7. The software program of claim 6, further including replicating the selected card for printing by placing multiple instances of the card on the custom-size sheet/roll paper according to the custom page size and one photo card size of 3×5, 4×6, 5×7 or one business card size of 89×51 mm (US), 90×54 mm (China) and 91×55 mm (Japan); such that the placement minimizes the over-print/gap size between adjacent cards and minimizes the waist of the paper for the left/right and top/bottom margins.

8. The software program of claim 6, further including previewing the card on each photo page and processing each card by brightness, contrast, saturation, sharpness image adjustment functions, and printing each card according to the parameters of the image adjustment saved for each card.

9. The software program of claim 6, further including replicating the business/photo card on one or more photo pages and leaving minimum two mini-meters for paper margins, and minimum three mini-meters for over-print and the gap between adjacent cards.

10. The software program of claim 6, further including printing each card by calculating the 1^{st} line of the 1^{st} card, extending the line of the card by an amount for the over-print in both directions, adding the gap between the over-print of two adjacent cards, then calculating the 1^{st} line of the 2^{nd} card, combining the extended 1^{st} lines of the 1^{st} and 2^{nd} adjacent cards, then calculating the 1^{st} line of the 3^{rd} card of the same Y coordinate, and finally, sending the complete line of the same Y coordinate to the printer; then repeat the same steps by sending the 2^{nd}, 3^{rd} line and so on to complete the printing.

11. A computer station, program product, printer and cutter for in-house digital photo, ID photo, photo card, business/name card and post card processing and printing using standard page-size or customize-size sheet/roll paper, comprising the steps of:
(a) At a computer station running the program product, user selects the digital image(s) stored on the removable media such as Smart Media, Compact Disk, Flash Memory etc., or on hard disk;
(b) The program product composes or replicates the selected digital image(s) for printing by placing each image on the photo page according to the paper size, image size, number of copies, paper margins and gaps between adjacent images, and produces one or more photo pages for user to preview; user may adjust the brightness, contrast, saturation, sharpness of each image placed on the photo page;
(c) The program product prints each photo page by keeping the left margin equals to the right margin, and the top margin equals to the bottom margin, and extends four edges of the card to include over-print;
(d) User repeats the step (a), (b) and (c) if the photo card, business/name card, post card need processing and printing on the back side of each card;
(e) The printing device produces each photo page, and cutting device further divides the photo page to the finished size of photos, photo cards, business/name cards and post cards by cutting.

12. The computer station running the program product of claim 11, further including selecting the digital image(s) stored on the removable media that are connected to the printer which includes micro-processor running the program product.

13. The program product of claim 11, further including the software program running on the printer in composing or replicating the selected digital image(s) for printing by placing each image on the photo page according to the paper size, image size, number of copies, paper margins and gaps between adjacent images, and printing each photo page by keeping the left margin equals to the right margin, and the top margin equals to the bottom margin, and extends four edges of the card to include over-print.

14. The printing and cutting device of claim 11, further including a separate cutting device attached to the printer toward the end of paper printing path, The printer produces each photo page, and cutting device receives a finished photo page then further divides the photo page to the finished size of photos, photo cards, business/name cards and post cards.

15. The printing and cutting device of claim 1, further including a cutting device built inside the printer to become an integrated printing and cutting machine, the integrated machine running the software program, receiving parameters from user through the LCD display, processing the selected image(s), printing the photo pages, and producing the finished size of photos, photo cards, business/name cards and post cards.
